(19) United States
(12) Patent Application Publication
(10) Pub. No.: US 2015/0098231 A1
(43) Pub. Date: Apr. 9, 2015

(54) MOCKUP FOR FACILITATING DECISION OF SPACIAL PARAMETERS OF A DIRECT-TYPE LED BACKLIGHT MODULE

(71) Applicant: HON HAI PRECISION INDUSTRY CO., LTD., New Taipei (TW)

(72) Inventor: YUN-YU CHOU, Tu-Cheng (TW)

(73) Assignee: HON HAI PRECISION INDUSTRY CO., LTD., New Taipei (TW)

(21) Appl. No.: 14/108,220

(22) Filed: Dec. 16, 2013

(30) Foreign Application Priority Data
Oct. 8, 2013 (TW) 102136299

(51) Int. Cl. F21V 21/14

(52) U.S. Cl. CPC F21V 21/14
USPC 362/418

(57) ABSTRACT

A mockup of a direct-type LED backlight module includes a base, a plurality of sliding bars slideably received in the base, a plurality of sliding plates slideably mounted the sliding bars, a supporting board positioned above the base and a plurality of connection elements fixing the supporting board to the base. A distance between the supporting board and the base is adjustable by manipulating the connection elements. A middle of an upper surface of the base is depressed downwardly to define a chamber, and the chamber is surrounded by a bottom surface, two opposite first lateral surfaces and two opposite second lateral surfaces. Each sliding bar is received in the chamber. Each sliding plate includes a holding plate on which an LED light source is mounted. A diffusion plate is mounted on the supporting board.

### BACKGROUND

1. Technical Field

The present disclosure relates to a mockup for facilitating the manufacturing of a direct-type LED backlight module, and particularly to a position-adjustable mounting for forming the mockup of the direct-type LED backlight module wherein distances between LEDs and a distance between the LEDs and a diffusion plate can be easily adjusted and measured whereby optimal parameters about the distances can be easily decided for facilitating the manufacturing of the real products of the direct-type LED backlight module.

2. Description of Related Art

LEDs (light emitting diodes) have been widely promoted as light sources of electronic devices owing to many advantages, such as high luminosity, low operational voltage and low power consumption.

A direct-type LED backlight module includes a plurality of LED light sources and a diffusion plate located over and on the light paths of the plurality of LED light sources. A thickness of the backlight module is determined by a distance between the diffusion plate and the LED light sources. When the distance between the diffusion plate and the LED light sources is small, the thickness of the backlight module is less. However, when the thickness of the backlight module is less, to obtain a uniform light field of the backlight module, the amount of the LED light sources needs to be increased, whereby the cost is increased. Thus, a balance between the thickness and the cost of the backlight module is needed. In manufacturing process of the backlight module, it needs to try many times to obtain the balance, whereby the manufacturing cost of the backlight module is high. It would be helpful if the balance can be obtained without the necessity of discarding many mockup samples of the backlight module after many try-and-errors.

Therefore, a position-adjustable mounting and a mockup including the position-adjustable mounting which are capable of meeting the requirement are desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a schematic view of a mockup of a backlight module using a position-adjustable mounting in accordance with an embodiment of the present disclosure.

FIG. 2 shows an exploded view of the mockup of FIG. 1.

FIG. 3 shows an inverted view of the mockup of FIG. 2.

### DETAILED DESCRIPTION

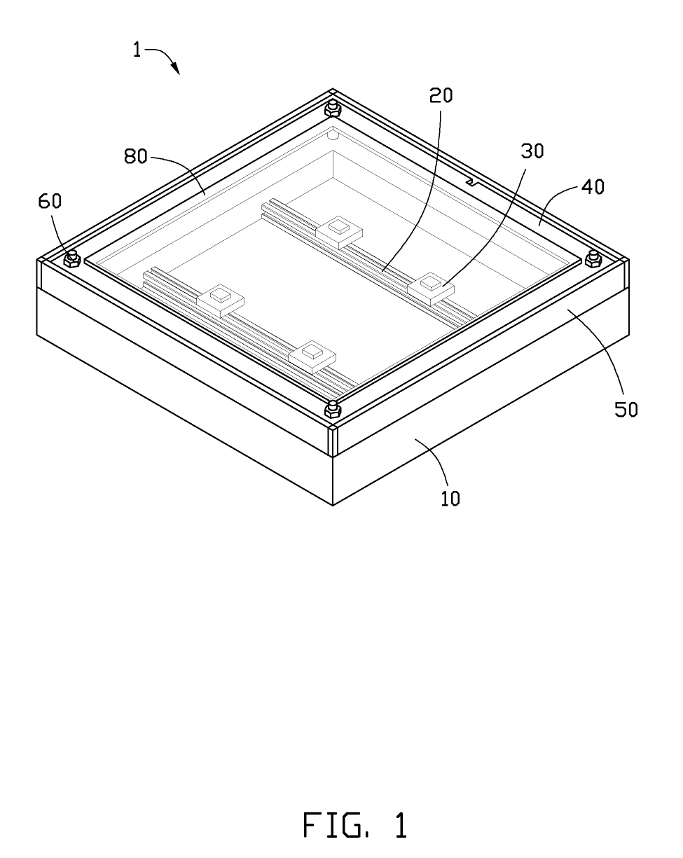

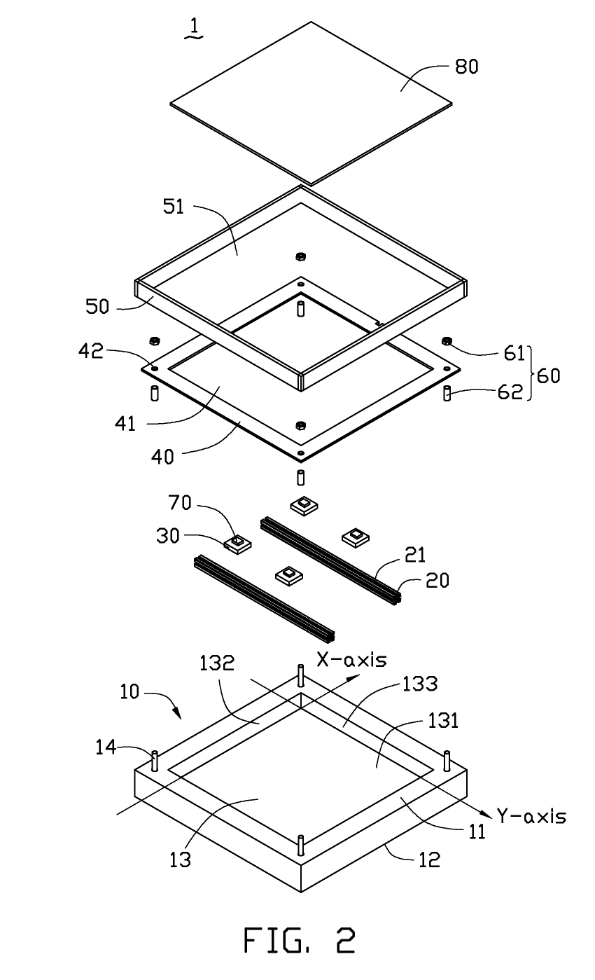

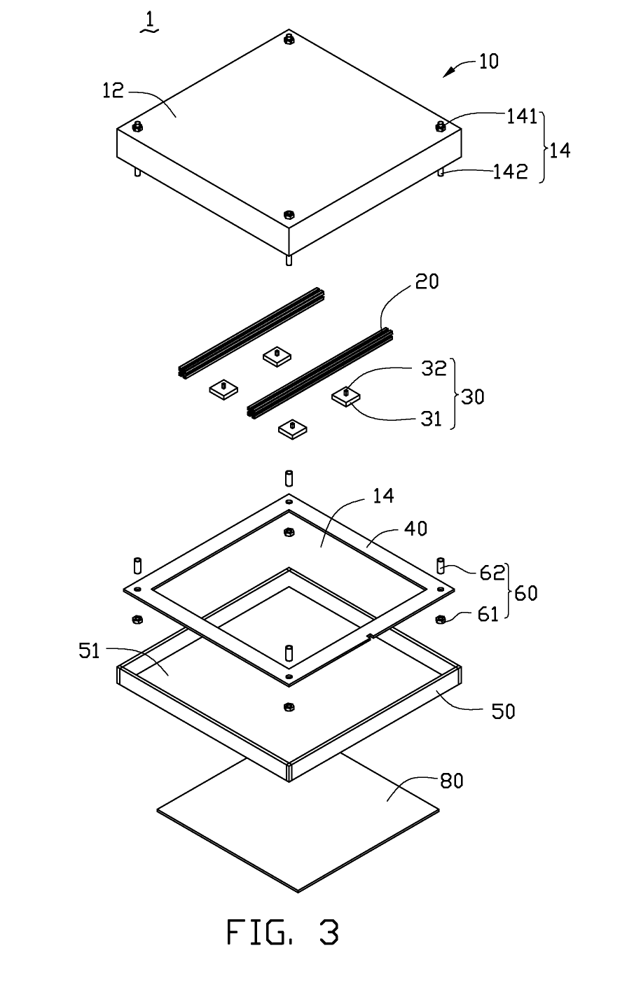

Referring to FIGS. 1-3, a mockup 1 of a direct-type LED backlight module using a position-adjustable mounting in accordance with an embodiment of the present disclosure includes a base 10, a plurality of sliding bars 20 received in the base 10, a plurality of sliding plates 30 slideably connecting with the sliding bars 20, a supporting board 40 positioned above the base 10, a baffle 50 around the supporting board 40 and a plurality of connection elements 60 fixing the supporting board 40 to the base 10. Each sliding plate 30 has an LED light source 70 securely mounted thereon. The mockup 1 is used for adjusting and deciding the distance between two adjacent LED light sources 70 and the distance between the LED light sources 70 and the diffusion plate 80 to thereby obtain the optimal special parameters of these distances which can reach a point of balance for the cost the direct-type backlight module which is mainly concerned with the quantity of the LED light sources 70 and a thickness of the direct-type backlight module. Presently, a thickness of a display device such as an LCD (liquid crystal display) having a direct-type backlight module is required to be smaller and smaller.

The diffusion plate 80 is a thin plate, and the diffusion plate 80 can diffuse the light which projects to the diffusion plate 80, whereby the light can be more uniformly projected to an object.

The base 10 is a rectangle plate, and includes an upper surface 11 and a lower surface 12 opposite to the upper surface 11. Middle of the upper surface 11 of the base 10 is depressed downwardly to define a rectangle chamber 13, and the chamber 13 is defined by a bottom surface 131, two opposite first lateral surfaces 132 and two opposite second lateral surfaces 133. The bottom surface 131, the first lateral surface 132 and the second lateral surface 133 are perpendicular to each other. A line connecting the first lateral surface 132 and the bottom surface 131 is defined as X-axis, and a line connecting the second lateral surface 133 and the bottom surface 131 is defined as Y-axis.

Four screws 14 are formed on the four corners of the base 10 respectively. Each of the screws 14 includes a head 141 and a pole 142 extending from one end of the head 141. A thread is formed on the outer surface of the pole 142 of each screw 14. The pole 142 penetrates the base 10 from the lower surface 12 and one free end of the pole 142 remote from the head 141 is extended upwardly beyond the upper surface 11. The head 141 firmly engages with the lower surface 12 of the base 10.

The plurality of sliding bars 20 is received in the chamber 13 of the base 10 and located on the bottom surface 131. Two end portions of each of the sliding bars 20 can slide along the X-axis on the two first lateral surfaces 132. An upper surface of each of the sliding bars 20 is depressed downward and defines an elongated sliding groove 21. In this embodiment, each sliding bar 20 is integrally formed as a single piece made of aluminum by extrusion. A length of each sliding bar 20 is equal to a perpendicular distance between the two first lateral surfaces 132, i.e., a length of the second lateral surface 133, and the sliding groove 21 extends along the Y-axis.

The plurality of sliding plates 30 is used for mounting the plurality of LED light sources 70 thereon, and each of the sliding plates 30 is mounted with one LED light source 70 thereon. Each sliding plate 30 includes a holding plate 31 and a sliding column 32 extending from a bottom side of the holding plate 31. The sliding column 32 is received in the sliding groove 21 of the sliding bar 20 and guides the holding plate 31 to slide along the Y-axis.

The supporting board 40 is a square frame. The supporting board 40 defines a square first through hole 41 at the middle thereof, and the first through hole 41 is corresponding to the chamber 13 of the base 10. The supporting board 40 further defines four connecting holes 42 on four corners thereof, and each of the connecting holes 42 is corresponding to one screw 14 of the base 10. In this embodiment, the supporting board 40 is used for mounting the diffusion plate 80 thereon. An inner size of the supporting board 40 is less than that of the diffusion plate 80 (which means that the supporting board 40 is larger than the first through hole 41), and an outer size of the supporting board 40 is slightly less than that of the base 10.

The baffle 50 is a square frame, and defines a square second through hole 51 at the middle thereof. The second through hole 51 is corresponding to the external periphery of the supporting board 40, whereby a size of the second through hole 51 is larger than that of the first through hole 41 and the diffusion plate 80. In this embodiment, a height of the baffle 50 is larger than that of the supporting board 40, and an inner size of the baffle 50 is equal to the outer size of the supporting board 40, and an outer size of the baffle 50 is equal to an outer size of the base 10. The baffle 50 is made of bakelite, wherein the bakelite is green which can prevent the light from penetrating through the baffle 50 and facilitate a visual measurement of a distance between the LED light sources 70 and the diffusion plate 80 to decide a thickness of the direct-type backlight module to be produced in accordance with the mockup 1 after a balance between the number of the LED light sources 70 and the distance between the LED light sources 70 and the diffusion plate 80 is obtained while an acceptable illumination profile by the mockup 1 is also attained.

Each of the connection elements 60 includes a screw nut 61 and an elastic component 62. In this embodiment, an amount of the connection elements 60 is four, and the elastic component 62 is a helical spring.

In use of the mockup 1, first, the distance between the two adjacent LED light sources 70 along the X-axis is adjusted by sliding the sliding bars 20 along the X-axis. Second, the distance between the two adjacent LED light sources 70 along the Y-axis is adjusted by sliding the sliding plates 30 on which the LED light sources 70 are mounted along the sliding grooves 21 of the sliding bars 20. Thus, the positions of the plurality of LED light sources 70 are predetermined. The positions and the number of the LED light sources 70 can be easily adjusted by adding more sliding bars 20 and more LED light sources 70 to the base 10 and sliding the sliding bars 20 and the sliding plates 30 to other positions, if desired. Third, four elastic components 62 are installed on the poles 142 of the screws 14, respectively. The supporting board 40 is mounted to the four elastic components 62 with the poles 142 of the screws 14 being extended through the connecting holes 42 of the supporting board 40. Then the screw nuts 61 are engaged with top ends of the poles 142, respectively. The diffusion plate 80 is put on the supporting board 40 to cover the first through hole 41. Fourth, the level of the supporting board 40 is adjusted by screwing in or screwing out the four screw nuts 61 along the poles 142 whereby the level of the diffusion plate 80 is adjusted correspondingly. The elastic components 62 are resiliently compressed between the supporting board 40 and the base 10. Therefore, the distance between the LED light sources 70 and the diffusion plate 80 can be adjusted by adjusting the heights of the four screw nuts 61. Then the baffle 50 is brought to be mounted on the upper surface 11 of the base 10, surrounding the supporting board 40 and the diffusion plate 80. An outer surface of the baffle 50 is coplanar with an outer surface of the base 10.

When the plurality of LED light sources 70 are at work, the distance between the two adjacent LED light sources 70 and the distance between the LED light sources 70 and the diffusion plate 80 can be adjusted until they achieve a balance between the distances and brightness and uniformity of light emitted from the plurality of LED light sources 70 through the diffusion plate 80. Then, values of the distance between the two adjacent LED light sources 70 and the distance between the LED light sources 70 and the diffusion plate 80 are recorded, respectively, and the values are applied as special parameters in the process of manufacturing actual LED backlight modules, thereby avoiding to a waste and cost due to discard of numerous mockups after repeat try-and-errors. The value of the distance between the LED light sources 70 and the diffusion plate 80 can be figured out by measuring a distance between a top of the baffle 50 and a top of the supporting board 40 when the distance between the LED light sources 70 and the top of the baffle 50 is known. Accordingly, the mockup 1 including the position-adjustable mounting in accordance with the present disclosure (which is equal to the makeup 1 minus the LED light sources 70 and the diffusion plate 80) can save the time and cost in manufacturing the direct-type LED backlight module.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A position-adjustable mounting for a mockup of a direct-type LED (light emitting diode) backlight module, comprising:
a base with a middle of an upper surface of the base being depressed downwardly to define a chamber, and the chamber being surrounded by a bottom surface, two opposite first lateral surfaces and two opposite second lateral surfaces of the base;
a plurality of sliding bars received in the base, the plurality of sliding bars being received in the chamber and located on the bottom surface, two end portions of each of the sliding bars being slideably contacted with the two first lateral surfaces, each of the sliding bars defining a sliding groove therealong;
a plurality of sliding plates slideably mounted on the sliding bars, each of sliding plates comprising a holding plate and a sliding column extending from the holding plate, the sliding column being received in the sliding groove and guiding the holding plate to slide along a corresponding sliding bar defining the sliding groove, each of the sliding plates being configured for mounting of an LED light source thereon;
a supporting board positioned above the base, the supporting board being configured for receiving a diffusion plate thereon; and
a plurality of connection elements fixing the supporting board to the base, wherein a level of the supporting board is adjustable by manipulating the connection elements.

2. The position-adjustable mounting of claim 1, wherein the bottom surface, each first lateral surface and each second lateral surface are perpendicular to each other, an extending direction of the sliding groove is perpendicular to each of the first lateral surfaces.

3. The position-adjustable mounting of claim 1, wherein the plurality of connection elements comprise a plurality of screws, elastic elements and nuts, each of the screws comprises a head engaging a bottom of the base and a pole extending upwardly from the head through the base, a thread is formed on an outer surface of the pole of each screw, the supporting board defines a first through hole at the middle thereof and over the chamber of the base, the supporting board further defines a plurality of connecting holes, the pole of each screw further extends through a corresponding elastic component and a corresponding connecting hole of the supporting board in sequence to engage with a corresponding nut, the elastic components are resiliently compressed between the base and the supporting board.

4. The position-adjustable mounting of claim 3, wherein the elastic components are springs.

5. The position-adjustable mounting of claim 1 further comprising a baffle mounted on the base and surrounding the supporting board, wherein the baffle is made of green bakelite.

6. The position-adjustable mounting of claim 5, wherein a top of the baffle is higher than a top of the supporting board.

7. The position-adjustable mounting of claim 5, wherein an outer size of the baffle is equal to an outer size of the base.

8. The backlight module measuring device of claim 1, wherein each of the sliding bars is formed as a single piece by aluminum extrusion.

9. A mockup of a direct-type LED backlight module, comprising:
a base, a middle of an upper surface of the base being depressed downwardly to define a chamber, and the chamber being surrounded by a bottom surface, two opposite first lateral surfaces and two opposite second lateral surfaces;
a plurality of sliding bars received in the base, the plurality of sliding bars being received in the chamber and located on the bottom surface, two end portions of each of the sliding bars slideably engaging with the two first lateral surfaces, each of the sliding bars defining an elongated sliding groove therealong;
a plurality of sliding plates slideably mounted on the sliding bars, each of sliding plates comprising a holding plate and a sliding column extending from the holding plate, the sliding column being received in the sliding groove to guide a sliding of the holding plate along the sliding groove;
a plurality of LED light sources each mounted on the holding plate of a corresponding sliding plate;
a supporting board positioned above the base;
a baffle mounted on the base and surrounding the supporting board, the baffle being made of bakelite;
a plurality of connection elements fixing the supporting board to the base, wherein a distance between the supporting board and the base is adjustable by manipulating the connection elements; and
a diffusion plate mounted on the supporting board.

10. The mockup of claim 9, wherein the bottom surface, each first lateral surface and each second lateral surface are perpendicular to each other, an extending direction of the sliding groove is perpendicular to each of the first lateral surfaces.

11. The mockup of claim 9, wherein the plurality of connection elements comprise a plurality of screws, elastic elements and nuts, each of the screws comprises a head engaging a bottom of the base and a pole extending upwardly from the head through the base, a thread is formed on an outer surface of the pole of each screw, the supporting board defines a first through hole at the middle thereof and over the chamber of the base, the supporting board further defines a plurality of connecting holes, the pole of each screw further extends through a corresponding elastic component and a corresponding connecting hole of the supporting board in sequence to engage with a corresponding nut, the elastic components are resiliently compressed between the base and the supporting board.

12. The mockup of claim 11, wherein the elastic components are springs.

13. The mockup of claim 9, wherein the baffle is made of green bakelite.

14. The mockup of claim 13, wherein a top of the baffle is higher than a top of the supporting board.

15. The mockup of claim 13, wherein an outer size of the baffle is equal to an outer size of the base.

16. The mockup of claim 9, wherein each of the sliding bars is integrally formed as a single piece by aluminum extrusion.
